(19) United States
(12) Patent Application Publication
(10) Pub. No.: US 2006/0143314 A1
(43) Pub. Date: Jun. 29, 2006

(54) Remote USB videophone communication

(76) Inventors: Shailendra Sinha, Hillsboro, OR (US); Dzung Tran, Beaverton, OR (US); Imtiaz Sajwani, Chandler, AZ (US)

Correspondence Address: Buckley, Maschoff & Talwalkar LLC;Attorneys for INTEL Corporation, Five Elm Street, New Canaan, CT, 06840, US

(21) Appl. No.: 11/025,130

(22) Filed: Dec. 29, 2004

(51) Int. Cl. G06F 3/00

(52) U.S. Cl. 710/5

(57) ABSTRACT

According to some embodiments, remote USB videophone communication is provided. In some embodiments, systems and methods may include receiving first audio and video information from a first user device and emulating the first user device as a universal serial bus device on a universal serial bus host. The systems and methods may further include receiving, from the universal serial bus host, second audio and video information associated with a second user device, and sending the second audio and video information to the first user device.

### BACKGROUND

Individuals often communicate utilizing conventional telephones that operate on a Public Switched Telephone Network (PSTN) and allow the individuals to share and exchange voice communications (i.e., audio information). Often, however, an individual may also desire to view the party on the other end of the connection (e.g., by sharing and exchanging images or video information in addition to the audio information). To meet this need, videophones have been developed that allow individuals to both see and hear a party on the other end of the connection. Typical videophones and/or videophone networks, however, may not be desirable and/or practicable in some situations.

### BRIEF DESCRIPTION OF THE DRAWINGS

FIG. 1 is a block diagram of a system according to some embodiments.

FIG. 2 is a block diagram of a system according to some embodiments.

FIG. 3 is a flow diagram of a method according to some embodiments.

FIG. 4 is a block diagram of a system according to some embodiments.

FIG. 5 is a flow diagram of a method according to some embodiments.

FIG. 6 is a block diagram of a system according to some embodiments.

FIG. 7 is a block diagram of a system according to some embodiments.

FIG. 8 is a block diagram of a system according to some embodiments.

### DETAILED DESCRIPTION

Some embodiments herein are associated with “information” or “data”. As used herein, the terms “information” and “data” may be used interchangeably and may refer to any data, text, voice, video, image, message, bit, packet, pulse, tone, waveform, and/or other type or configuration of signal and/or information. Information may be or include information packets transmitted, for example, in accordance with the Internet Protocol Version 4 (IPv4) standard as defined by “Internet Protocol” RFC 791, Defense Advance Research Projects Agency (DARPA), published by the Information Sciences Institute, University of Southern California, J. Postel, ed. (September 1981), and/or the Internet Protocol Version 6 (IPv6) standard as defined by “Internet Protocol Version 6 (IPv6) Specification” RFC 2460, published by the Internet Engineering Task Force (IETF), Network Working Group, S. Deering et al. (December 1998). Information may, according to some embodiments, be compressed, encoded, encrypted, and/or otherwise packaged or manipulated in accordance with any method that is or becomes known.

In addition, some embodiments described herein are associated with “information indicative of” or “indicia” of information associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information.

Some embodiments described herein are associated with a “user device”. As used herein, the phrase “user device” may refer to any device that can communicate via a network and/or be utilized by a user. Examples of user devices include a Personal Computer (PC), a workstation, a server, a printer, a scanner, a facsimile machine, a copier, a Personal Digital Assistant (PDA), a storage device (e.g., a disk drive), a hub, a router, a switch, and a communication device (e.g., a modem, a wireless phone, etc.). User devices may comprise one or more components, such as a Static Random Access Memory (SRAM) device or module, a network processor, and a network communication path, connection, port, or cable.

In addition, some embodiments are associated with a “network” or a “communication network”. As used herein, the terms “network” and “communication network” may be associated with the transmission of messages, packets, signals, and/or other forms of information between and/or within one or more network and/or user devices. By way of example, a network may be configured to operate in accordance with the Fast Ethernet LAN transmission standard 802.3-2002 published by the Institute of Electrical and Electronics Engineers (IEEE).

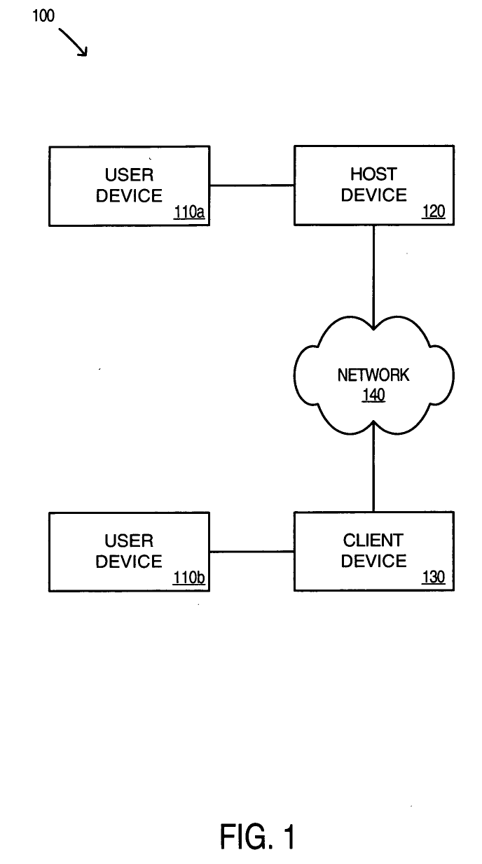

Referring first to FIG. 1, a block diagram of a system 100 according to some embodiments is shown. The various systems described herein are depicted for use in explanation, but not limitation, of described embodiments. Different types, layouts, quantities, and configurations of any of the systems described herein may be used without deviating from the scope of some embodiments. Fewer or more components than are shown in relation to the systems described herein may be utilized without deviating from some embodiments.

The system 100 may comprise, for example, one or more user devices 110a-b, a host device 120, and/or a client device 130. Any of the components 110a-b, 120, 130 of the system 100 may be coupled and/or otherwise may be in communication via the network 140. In some embodiments, the first user device 110a may be in communication with the host device 120 and/or the second user device 110b may be in communication with the client device 130. According to some embodiments, the client device 130 may be in communication with the host device 120 via the network 140. The network 140 may be or include any quantity, configuration, and/or type of network that is or becomes known or practicable. In some embodiments, the network 140 may be a wired and/or wireless IP network. Any of the components 110a-b, 120, 130 of the system 100 may, according to some embodiments, include, be included within, and/or may otherwise be associated with a computing and/or mobile electronics device such as a PC, a notebook computer, a PDA, and/or a wireless telephone or other device.

In some embodiments, the second user device 110b may be a user device that is not equipped with and/or otherwise provided with an interface configured in accordance with the Universal Serial Bus (USB) interface standard as described in the USB Specification Revision 2.0 (2000), and/or is remotely located from the host device 120. For example, the second user device 110b may be a wireless videophone that does not have USB functionality (e.g., in which case the second client device 110b may be unable to communicate with the host device 120 in accordance with the USB protocol). The second client device 110b may also or alternatively be remotely located from the host device 120 (e.g., in which case the second client device 110b may be unable to be physically connected to the host device 120 in accordance with the USB protocol). According to some embodiments, the host device 120 may be a PC and/or other network device that is equipped with USB functionality. The host device 120 may, for example, be a PC or notebook computer having one or more USB ports and/or a USB chipset for providing an interface with USB devices.

According to some embodiments, the client device 130 may interface with the host device 120 (e.g., via the network 140) to provide USB functionality to the second user device 110b. The second user device 10b may, for example, provide a USB or non-USB output to the client device 130. The client device 130 may then, according to some embodiments, connect to the host device 120 and provide the output to the host device 120. The output may, according to some embodiments, be emulated as a USB output to the host device 120.

Audio and/or video input from the second user device 110b may, for example, be forwarded by the client device 130 and received as one or more USB packets by the host device 120 and/or may be processed (e.g., by the host device 120) as a USB output from an emulated USB device (e.g., the second user device 110b). In other words, the output received from the client device 130 may be viewed and/or treated as an output from a USB device connected to the host device 120. Further, the first user device 110a coupled to the host device 120 may be interfaced with the client device 130 to provide audio and/or video output to the client device 130. As an example, the first user device 110a may communicate with the second user device 110b via the host device 120 and the client device 130 by using the host device 120 as a USB interface (e.g., USB-bridging). In some embodiments, the host device 120 may provide remote USB-bridging.

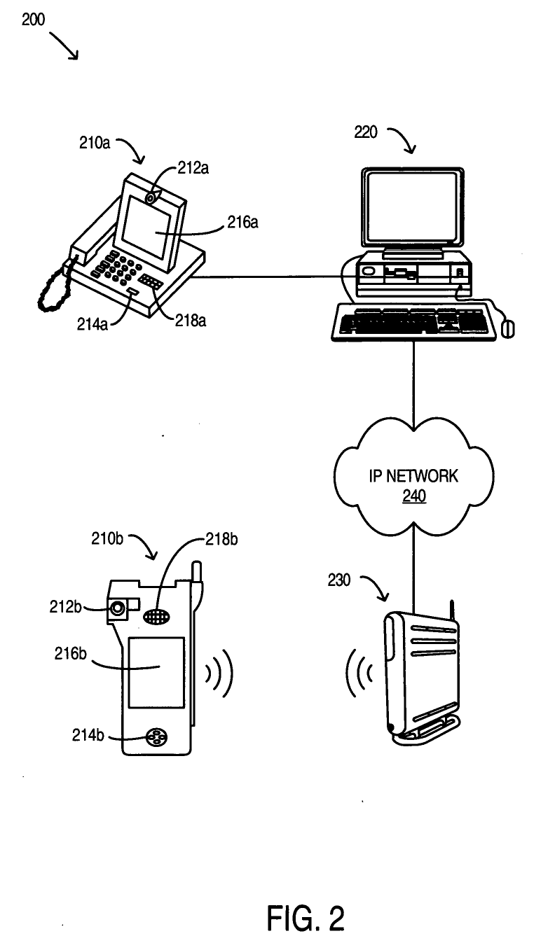

Referring in more detail to FIG. 2, a block diagram of a system 200 according to some embodiments is shown. The system 200 may include, according to some embodiments, one or more user devices 210a-b. The user devices 210a-b may include, for example, a camera 212a-b, a microphone 214a-b, a display device 216a-b, and/or a speaker 218a-b. The system 200 may also or alternatively include one or more host devices 220 and/or one or more client devices 230. The user devices 210a-b, the host device 220, and/or the client device 230 may, according to some embodiments, be coupled, connected, and/or otherwise in communication (e.g., via a network such as the IP network 240). In some embodiments, the components 210, 220, 230, 240 of the system 200 may be similar in configuration and/or functionality to the similarly-named components described in conjunction with FIG. 1. In some embodiments, fewer or more components than are shown in FIG. 2 may be included in the system 200.

The second user device 210b may, as shown in FIG. 2 for example, be a wireless videophone. In some embodiments, a user of the wireless videophone 210b may desire to conduct a videophone session with a user of the first user device 210a. The first user device 210a may, for example, be a wired videophone. According to some embodiments, the wireless videophone 210b may not be capable of communicating directly with the wired videophone 210a. The wired videophone 210a may be connected to a PSTN (not shown), for example, while the wireless videophone 210b may be configured to operate in accordance with the Wireless Local Area Network (WLAN) standard 802.11h-2003 published by the IEEE. In some embodiments, the videophones 210a-b may be otherwise out of range and/or not capable of direct communication. According to some embodiments, the videophones 210a-b may be capable of direct communication, yet conducting a videophone session utilizing the system 200 may be desired and/or otherwise preferable or practicable.

In some embodiments, the user of the wireless videophone 210b may initiate a videophone session by, for example, selecting and/or otherwise identifying the wired videophone 210a and/or the user of the wired videophone 210a. The user of the wireless videophone 210b may, according to some embodiments, select an image of the user of the wired videophone 210a from the display 216b of the wireless videophone 210b. According to some embodiments, the user of the wireless videophone 210b may input audio and/or video information into the wireless videophone 210b by utilizing either or both of the camera 212b and the microphone 214b (e.g., the user may initiate a videophone “call”).

The audio and/or video information may, in some embodiments, be sent from the wireless videophone 210b to the client device 230. The wireless videophone 210b and the client device 230 may, for example, communicate in accordance with the “Information Technology—Telecommunications And Information Exchange Between Systems—Local And Metropolitan Area Networks” standard 802.11b-1999 published by the IEEE. In some embodiments, the client device 230 may be or include a Digital Media Adapter (DMA) such as a Linksys® Wireless-B™ Media Adapter. The client device 230 may, according to some embodiments, process the audio and/or video information received from the wireless videophone 210b, and/or transmit the information over the IP network 240 (such as the Internet) to the host device 220. In some embodiments, the audio and/or video information may be sent to the host device 220 as USB packets.

In some embodiments, the client device 230 may emulate the wireless videophone 210b as a USB device connected to the host device 220. In the case that the wireless videophone 210b is not USB-capable, for example, the client device 230 may convert and/or otherwise process the received audio and/or video information into one or more USB packets. The USB packets may then, according to some embodiments, be sent to the host device 220 over the IP network 240. The packets may be received, for example, as if they had originated from a USB device connected directly to the host device 220.

According to some embodiments, the host device 220 may then forward the audio and/or video information to the wired videophone 210a. The wired videophone 210a may then, for example, display any received video information via the display device 216a and/or provide any received audio information via the speaker 218a. In some embodiments, the host device 220 may serve as a USB-bridging host to multiple user devices 210. According to some embodiments, the host device 220 may include switching software and/or hardware that facilitates the management of videophone sessions. The information received from the client device 230 may, for example, include information identifying (and/or indicative of) the user of the wired videophone 210a and/or the wired videophone 210a. The host device 220 may determine, for example, which user device 210 is intended to receive the information and may forward the information to the appropriate user device 210 (such as the wired videophone 210a).

The host device 220 may also or alternatively facilitate videophone communication from the wired videophone 210a. In the case that the wired videophone 210a receives and provides (e.g., to a user) the audio and/or video information from the wireless videophone 210b, for example, the user of the wired videophone 210a may input audio and/or video information into the wired videophone 210a. The audio and/or video information from the wired videophone 210a may, according to some embodiments, be captured and/or otherwise received by the host device 220. The host device 220 may then, for example, provide the information to the client device 230, which may forward the information to the wireless videophone 210b. In such a manner, for example, the users of the videophones 210a-b may conduct a videophone session (e.g., exchange audio and video information) utilizing remote USB-bridging over the IP network 240.

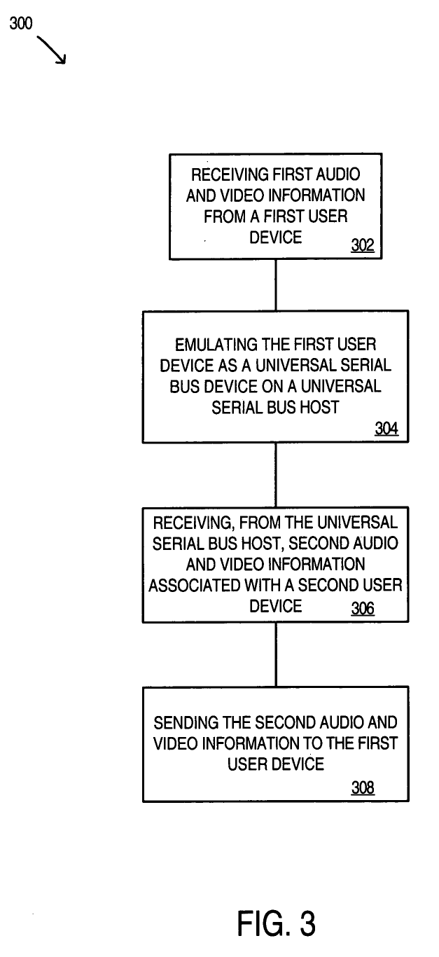

Referring now to FIG. 3, a method 300 according to some embodiments is shown. In some embodiments, the method 300 may be conducted by and/or by utilizing the systems 100, 200 and/or may be otherwise associated with the systems 100, 200 and/or any of the system components described in conjunction with any of FIG. 1 and/or FIG. 2. The method 300 may, for example, be performed by and/or otherwise associated with the client device 130, 230 described herein. The flow diagrams described herein do not necessarily imply a fixed order to the actions, and embodiments may be performed in any order that is practicable. Note that any of the methods described herein may be performed by hardware, software (including microcode), firmware, manual means, or any combination thereof. For example, a storage medium may store thereon instructions that when executed by a machine result in performance according to any of the embodiments described herein.

In some embodiments, the method 300 may begin at 302 by receiving first audio and video information from a first user device. In some embodiments, the first user device may be operated by and/or otherwise associated with a first user. A DMA device such as the client device 130, 230 may, in some embodiments, receive audio and/or video information from the first user device (such as the wireless videophone 110b, 210b). According to some embodiments, the audio and/or video information may be received via a network such as an 802.11b network, a Bluetooth® network, and/or any other type or configuration of wireless and/or wired networks. The information may, for example, be or include videophone information sent from the first user device. In some embodiments, the information may include, but is not limited to, audio information (e.g., voice of the first user), video information (e.g., an image and/or video of a first user), routing information, and/or other videophone session information (such as the identity and/or address of the party to be called).

The information may, according to some embodiments, be received as USB information from the first user device. The first user device may, for example, include a USB microphone and/or a USB camera by which audio and video of the first user, respectively, are captured. In some embodiments, the information may be received in one or more other formats and/or in accordance with one or more other protocols and/or standards. The first user device may, for example, not be USB-capable.

According to some embodiments, the method 300 may continue by emulating the first user device as a USB device on a USB host, at 304. The USB host may, for example, be a PC with USB functionality that is capable of providing remote USB-bridging services. In other words, a potentially non-USB user device and/or a potentially remote user device (e.g., remote from the USB host) may be loaded, installed, and/or otherwise interfaced with the USB host (e.g., the host device 120, 220) as a local USB device (e.g., local to the host). In some embodiments, the USB host may load a driver and/or otherwise install, initiate, and/or configure the emulated USB device. As an example, the first user device may be a wireless videophone that may be interfaced with the USB host as a local USB videophone.

According to some embodiments, a software and/or other application or module on the client device, such as a USB control transfer application, may conduct and/or manage the device emulation. In some embodiments, the emulation may also or alternatively be conducted by and/or at the USB host. In some embodiments, such as in the case that the first client device in not USB-capable, the client device may convert and/or otherwise process the first audio and video information to provide the first audio and video information as USB packets over an IP network to the USB host. In some embodiments, the client device may convert the first audio and video information into one or more USB packets and transmit the packets over a network (e.g., the network 140, 240) to the USB host.

An application resident on the client device may, for example, structure and/or package audio and/or video information as one or more USB packets. The USB packets may, according to some embodiments, be sent to the USB host over an IP network (e.g., the IP network 240). The USB packets may be received by the USB host, for example, as if they had originated from a local USB device (e.g., the emulated USB device). In some embodiments, a user device that lacks USB functionality and/or is remotely located from the USB host may accordingly utilize the USB-bridging services of the USB host to provide videophone session information (e.g., audio and/or video information and/or other communication information).

The method 300 may continue at 306 by receiving, from the USB host, second audio and video information associated with a second user device. The USB-bridging service of the USB host may, for example, be utilized to conduct a videophone session between the first and second user devices. In other words, the first user device may communicate with the second user device via the remote USB connection between the client device and the USB host. According to some embodiments, the client device and/or the functionality of the client device may be incorporated into the first user device. The first user device may, for example, be capable of providing USB packets over an IP network to the USB host and/or may otherwise be capable and/or configured to conduct remote USB-bridging client-side functions.

In some embodiments, the first audio and video information may be sent, by the USB host, to the second user device. According to some embodiments, a second user associated with the second user device may respond to the first audio and video information by providing the second audio and video information as input to the second user device. The USB host may, for example, capture the second audio and video information from the second user device and forward the second audio and video information to the client device. According to some embodiments, the second audio and video information may be encoded, compressed, and/or encrypted prior to being sent to the client device.

The second audio and video information may be received as one or more USB packets over an IP network. The second audio and video information may, for example, be sent by the USB host as if it where USB information being sent to a locally-connected USB device. According to some embodiments, the received second audio and video information may be decoded, decompressed, and/or decrypted. The client device may, for example, process, decode, decompress, decrypt, and/or otherwise manage the received second audio and video information. In some embodiments, the client device may convert the second audio and video information into one or more formats recognized and/or utilized by the first user device.

In some embodiments, the method 300 may continue by sending the second audio and video information to the first user device, at 308. The second audio and video information may, for example, be sent to the first user device via the same connection, port, cable, and/or network via which the first audio and video information was received. According to some embodiments, the sending of the second audio and video information to the first user device may complete initiation of the videophone session. Once both the first and second users have exchanged initial communications (e.g., the first and second audio and video information), for example, the users may continue to communicate (e.g., via the system 100, 200) to conduct the videophone session. In some embodiments, the second audio and video information may be sent to the first user device as USB information (such as in the case the first user device is a USB-capable device). According to some embodiments, the second audio and video information may be converted, decoded, decompressed, decrypted, and/or otherwise processed prior to being sent to the first user device.

In some embodiments, the first user device may comprise various components such as a camera (e.g., the camera 212), a microphone (e.g., the microphone 214), a display device (e.g., the display device 216), and/or a speaker (e.g., the speaker 218). The first audio and video information may, for example, be comprised of both audio and video components that are received from the microphone and the camera, respectively. According to some embodiments, the second audio and video information may be provided to one or more of the various components of the first user device. The client device may, for example, send an audio portion of the second audio and video information to the speaker of the first user device and/or may send a video portion of the second audio and video information to the display device of the first user device. The first user device may, for example, be comprised of the various components that may be independently and/or individually connected and/or coupled to the client device. The first client device may be comprised of the various components that may, for example, be capable of performing together as a videophone by utilizing the services and/or functionalities provided by the client device.

According to some embodiments, the USB host and/or the first client device may be identified and/or detected. A client device (such as a client device 130, 230) may, for example, perform a search for a host that is capable of providing USB-bridging services. According to some embodiments, Bluetooth® technology may be used to actively discover a USB host. In some embodiments, the USB host may be otherwise identified, determined, and/or located. The USB host may, for example, transmit a signal to assist a client device in locating and/or identifying the USB host. In some embodiments, the client device may store a list of available USB hosts and/or may otherwise lookup an address, identifier, and/or locator associated with the USB host. In some embodiments, one or more available USB hosts may be selected, identified, and/or otherwise chosen. The first client device (and/or other client devices) may similarly be identified, detected, and/or otherwise determined.

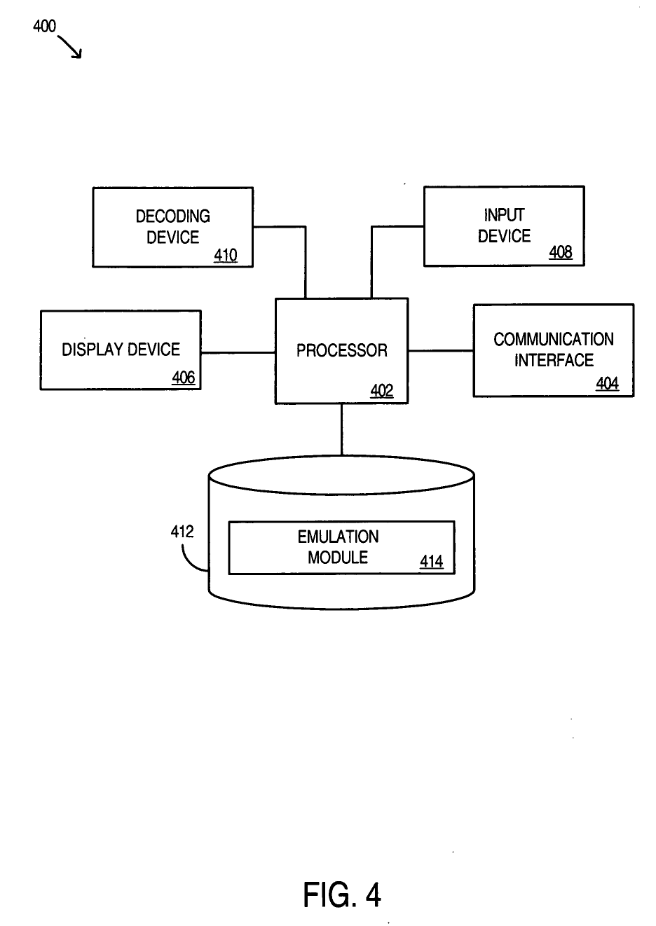

Turning now to FIG. 4, a block diagram of a system 400 according to some embodiments is shown. The system 400 may, for example, be utilized to implement and/or perform the method 300 described herein and/or may be associated with the systems 100, 200 described in conjunction with any of FIG. 1 and/or FIG. 2. In some embodiments, fewer or more components than are shown in FIG. 4 may be included in the system 400. According to some embodiments, different types, layouts, quantities, and configurations of systems may be used.

In some embodiments, the system 400 may be or include a DMA and/or other network device. According to some embodiments, the system 400 may be a client device such as the client devices 130, 230 described herein. In some embodiments, the system 400 may be a wireless DMA device utilized to interface with a host device that provides USB-bridging services to allow a user device (such as a videophone) to interface with one or more other user devices. The system 400 may include, for example, one or more processors 402, which may be any type or configuration of processor, microprocessor, and/or micro-engine that is or becomes known or available. In some embodiments, the system 400 may also or alternatively include one or more communication interfaces 404, a display device 406, an input device 408, a decoding device 410, and/or a memory device 412, all and/or any of which may be in communication with the processor 402. The memory device 416 may store, for example, an emulation module 414.

The communication interface 404 may be or include any type and/or configuration of communication device that is or becomes known or available. In some embodiments, the communication device 404 may allow the system 400 (and/or the processor 402) to communicate with, for example, one or more user devices (e.g., user devices 110, 210) and/or one or more host devices (e.g., host devices 120, 220). According to some embodiments, the communication interface 404 may be or include a Network Interface Card (NIC) such as an Intel® PRO/1000 MT Desktop Adaptor that operates in accordance with the Fast Ethernet LAN transmission standard 802.3-2002 published by the IEEE, or an Intel® PRO/Wireless 2225BG Network Connection that operates in accordance with the Wireless LAN transmission standard 802.11b/g-1999/2003 published by the IEEE.

The display device 406 may be or include any type of display device that is or becomes known or practicable, including, but not limited to, a Cathode Ray Tube (CRT) display device, a Liquid Crystal Display (LCD) device, and/or a Light-Emitting Diode (LED) display device. In some embodiments, the display device 406 may not be included in the system 400. Output from the system 400 may be provided, for example, via one or more other devices. In some embodiments, the system 400 may provide a Graphical User Interface (GUI), for example, to another device such as a client device that comprises a display device to display the GUI. According to some embodiments, the display device 406 may comprise one or more lights or diodes that provide status and/or connectivity information based upon their illumination (and/or lack thereof).

The input device 408 may be or include one or more conventional devices such as a keyboard, a mouse, a remote control, a trackball, etc. The input device 408 may be utilized, for example, by an operator and/or system user to interface with the emulation module 414 running on the system 400 (e.g., executed by the processor 402) and/or to facilitate the interface between the system 400 and one or more host devices and/or user devices. In some embodiments, the input device 408 may be or include an Infrared Radiation (1R) interface to receive signals, commands, and/or other input from an IR remote control device (not shown). In some embodiments, other forms of remote control (e.g., Radio Frequency (RF) and/or carrier-line signaling) may also or alternatively be utilized.

In some embodiments, the system 400 may include the decoding device 410. The decoding device 410 may, for example, decode information received from a USB host. According to some embodiments, audio and/or video information (e.g., videophone session information) may be encoded and/or compressed by a USB host and sent to the client device (e.g., at 306). The audio and/or video information may then, for example, be decoded and/or decompressed by the decoding device 410. In some embodiments, the decoding device 410 may be capable of decoding information in accordance with any decoding standard that is or becomes known, including, but not limited to, the Moving Pictures Expert Group (MPEG) Release Two (MPEG-2) 13818 standard (1994) published by the International Standards Organization (ISO) and the International Electrotechnical Commission (IEC), the MPEG-4 14496 (1999/2002) standard published by ISO/IEC, the “Video coding for low bit rate communication” H.263 (February 1998) and/or the “Advanced video coding for generic audiovisual services” H.264/Advanced Video Coding (AVC) (May 2003) published by the International Telecommunication Union Telecommunication Standardization Sector (ITU-T), and/or the Advanced Systems Format (ASF) Specification Revision 01.20.2003 published by the Microsoft Corporation (December 2004). Other forms, standards, and/or types of decoding (and/or encoding) may be performed by the decoding device 410 without deviating from some embodiments.

The memory device 412 may be or include, according to some embodiments, one or more magnetic storage devices, such as hard disks, one or more optical storage devices, and/or solid state storage. The memory device 412 may store, for example, the emulation module 414. The emulation module 414 may be or include, for example, a USB control transfer module and/or application that is capable of emulating and/or facilitating the emulation of a USB device. The emulation module 414 may, according to some embodiments, emulate a USB user device (e.g., at 304) by providing audio and/or video information received from one or more user devices as USB packets to a host device over an IP network. The USB packets (and/or other form and/or configuration of output information provided by the emulation module 414) may, for example, be utilized by the host device as if they were received from a locally connected USB device (e.g., local to the host).

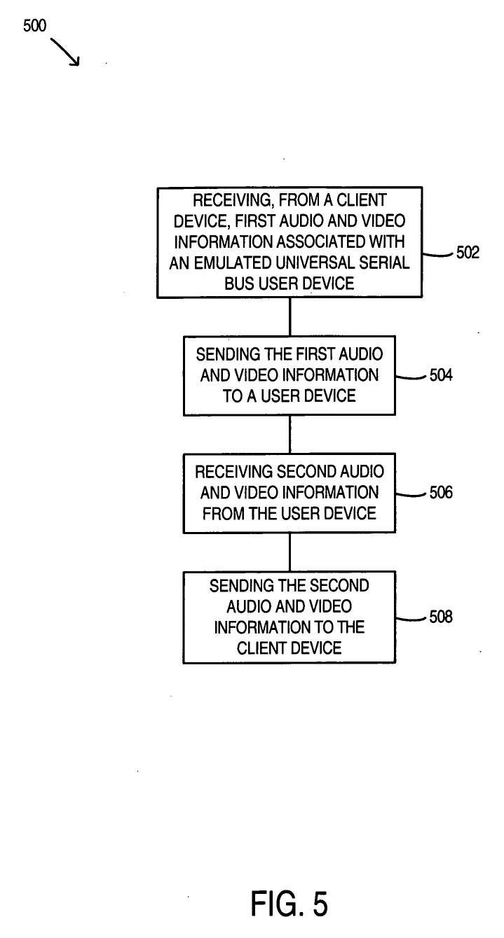

Referring now to FIG. 5, a method 500 according to some embodiments is shown. In some embodiments, the method 500 may be conducted by and/or by utilizing the systems 100, 200, 400 and/or may be otherwise associated with the systems 100, 200, 400 and/or any of the system components described in conjunction with any of FIG. 1, FIG. 2, and/or FIG. 4. The method 500 may, for example, be performed by and/or otherwise associated with the host device 120, 220 described herein.

In some embodiments, the method 500 may begin at 502 by receiving, from a client device, first audio and video information associated with an emulated USB user device. A host device (e.g., the host device 120, 220) such as a PC may, for example, receive information from a DMA device. The DMA device may, according to some embodiments, be or include a client device such as one or more of the client devices 130, 230 described herein. In some embodiments, the first audio and video information may include a USB packet sent via an IP network from a client device. The first audio and video information may, for example, be information indicative of an emulated USB output associated with a user device coupled to the client device. The USB packet and/or USB output may, according to some embodiments, represent and/or include information associated with audio and/or video input entered into the user device and provided to the client device. The first audio and video information may, for example, comprise information associated with a videophone session.

According to some embodiments, a driver may be loaded to facilitate the interface between a host device providing remote USB-bridging services and a client device that emulates a user device on the host device. The driver may, for example, be a software driver configured to manage the exchange of information between the host device and the emulated universal serial bus user device (and/or the client device). In some embodiments, such as in the case that the user device is a USB-capable device, the driver may be or include the same driver that would be loaded if the user device were directly connected and/or coupled to the host device. According to some embodiments, other drivers and/or code may be loaded and/or executed to enable the host device to interpret, utilize, and/or otherwise process the first audio and video information received from the client device.

The method 500 may continue, for example, by sending the first audio and video information to a user device, at 504. A user device may, for example, be coupled to and/or otherwise in communication with a host device such as a PC. The PC host device may, according to some embodiments, forward and/or pass the first audio and video information (e.g., received by the host PC at 502) to the user device. The host PC may, for example, function as a remote USB host gateway, facilitating the transmission of information between the user device and the emulated USB user device (e.g., a user device associated with the client device).

In some embodiments, such as in the case that multiple user devices are coupled to and/or in communication with the host PC, the host PC may include switching software and/or hardware that may be utilized to direct the first audio and video information to one or more of the connected user devices. The first audio and video information may include, for example, an indication associated with an intended destination user device (e.g., a called party's videophone). The host PC may, according to some embodiments, determine which of the available user devices associated with the host PC is the intended recipient of the first audio and video information. In some embodiments, the host PC itself may be or include a user device. The host PC may, for example, comprise a microphone, a speaker, a display device, and/or a camera, any or all of which may facilitate the operation of the host PC as a videophone user device. In the case that the host PC is the intended recipient user device, the first audio and video information may be sent, at 504, to a user associated with the host PC (i.e., instead of being sent to a separate user device).

According to some embodiments, the method 500 may continue at 506 by receiving second audio and video information from the user device. In the case that the host PC sent the first audio and video information to the user device at 504, for example, a user operating the user device may input the second audio and video information to send back to the host PC. In some embodiments, the user may input the second audio and video information at least in part in response to the receipt of the first audio and video information. In the case that the first audio and video information is associated with a videophone “call” (e.g., originated by a user device associated with the client device), for example, the user may respond to the information provided by the other user (e.g., by saying “Hello” and/or by waving). In the case that the host PC is the recipient user device, the second audio and video information may be received from one or more components of the host PC. The user may, for example, speak into a microphone and/or position themselves in front of a camera coupled to the host PC.

In some embodiments, the second audio and video information may be captured and/or otherwise acquired. The host PC may, for example, include audio and/or video capture devices (e.g., hardware and/or software devices) configured to capture input provided to the user device. In the case that a user of the user device provides audio and/or video input, for example, the host PC may capture the audio and/or video information to create and/or define the second audio and video information. In some embodiments, the host PC may monitor the user device to determine when input is received and/or otherwise becomes available. According to some embodiments, the host PC may monitor the user device during a videophone session (e.g., after the first audio and video information is provided to the user device, and until the videophone session is terminated).

The method 500 may continue at 508, according to some embodiments, by sending the second audio and video information to the client device. In other words, according to some embodiments, the response to the first audio and video information (e.g., the response to the videophone session initiation) may be provided to the originating party. The host PC may, for example, send the second audio and video information to the client device, which may then, according to some embodiments, forward the second audio and video information to the user device that the videophone session originated from (e.g., the emulated USB user device). In some embodiments, the host PC may encode, compress, encrypt, and/or otherwise process the second audio and video information prior to sending the second audio and video information to the client device. The second audio and video information may be encoded, for example, in accordance with the MPEG-2 or MPEG-4 standards. In some embodiments, other formats and/or standards may be used. According to some embodiments, any audio portions of the second audio and video information may be encoded and/or sent separately (e.g., via separate cables or wires) from any video portions of the second audio and video information.

According to some embodiments, the user device and/or the client device may be identified and/or discovered. The host PC (and/or the client device and/or the user device) may, for example, include “Plug-and-Play” functionality that allows the host PC to determine when a device is connected to the network (and/or to the host PC directly). In the case that the client device emulates a user device on the host PC, for example, the host PC may automatically detect, identify, and/or otherwise manage the newly connected and/or activated device. Device discovery and/or configuration may, according to some embodiments, be performed by Bluetooth® and/or in accordance with Universal Plug and Play (UPnP) networking architecture.

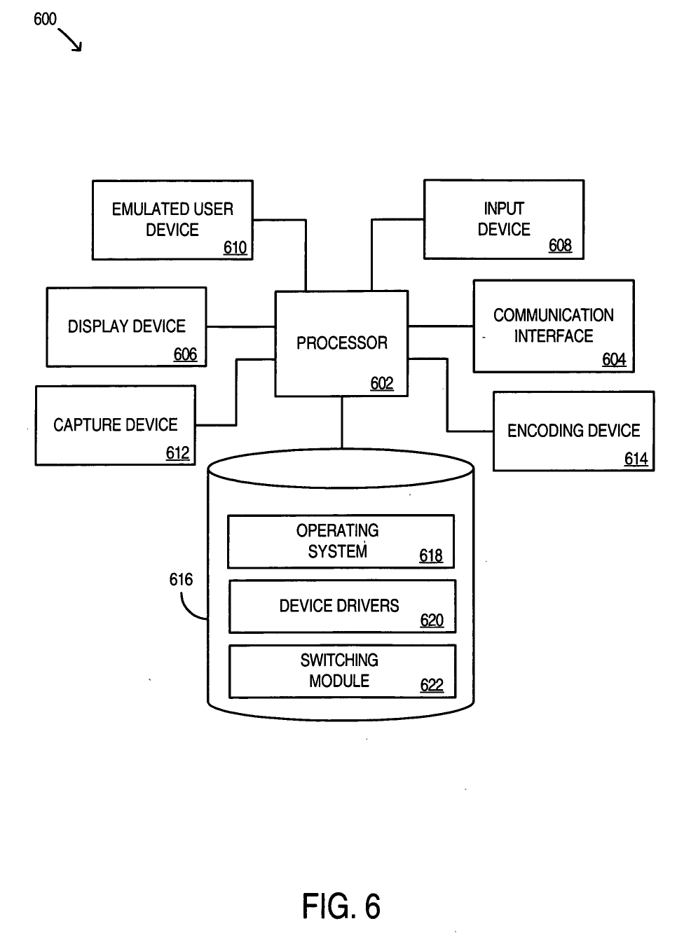

Turning now to FIG. 6, a block diagram of a system 600 according to some embodiments is shown. The system 600 may, for example, be utilized to implement and/or perform the method 500 described herein and/or may be associated with the systems 100, 200, 400 described in conjunction with any of FIG. 1, FIG. 2, and/or FIG. 4. In some embodiments, fewer or more components than are shown in FIG. 6 may be included in the system 600. According to some embodiments, different types, layouts, quantities, and configurations of systems may be used.

In some embodiments, the system 600 may be or include a computer such as a PC, a computer server, and/or a notebook computer. According to some embodiments, the system 600 may be a host computer such as the host device 120, 220 described herein. In some embodiments, the system 600 may be a computer utilized to facilitate the interface between one or more user devices (e.g., to conduct a videophone session). The system 600 may include, for example, one or more processors 602, which may be any type or configuration of processor, microprocessor, and/or micro-engine that is or becomes known or available. In some embodiments, the system 600 may also or alternatively include one or more communication interfaces 604, a display device 606, an input device 608, an emulated user device 610, a capture device 612, an encoding device 614, and/or a memory device 616, all and/or any of which may be in communication with the processor 602. The memory device 616 may store, for example, an operating system 618, device drivers 620, and/or one or a switching module 622.

The communication interface 604, the display device 606, and/or the input device 608 may be or include any types and/or configurations of devices that are or become known or available. In some embodiments, the components 604, 606, 608 of the system 600 may be similar in configuration and/or functionality to the similarly-named components described in conjunction with FIG. 4 herein. The input device 608 may be or include one or more conventional devices such as a keyboard, a mouse, a trackball, etc. The input device 608 may be utilized, for example, by an operator and/or system user to interface with the operating system 618 and/or the switching module 622 running on the system 600 (e.g., executed by the processor 602) and/or to facilitate the interface between two or more user devices (and/or one or more client devices).

According to some embodiments, the system 600 may include an emulated user device 610. The emulated user device 610 may, for example, be a user device and/or a representation of a user device. In some embodiments, the emulated user device 610 may be a user device that is treated like and/or viewed as a USB device and/or component by the system 600. The emulated user device 610 may, for example, be an emulated USB videophone and/or related device. In some embodiments, the emulated user device 610 may be or include a driver (such as one of the device drivers 620) and/or other component and/or device that facilitates the interface between the system 600 and a user device and/or a client device. According to some embodiments, the emulated user device 610 may be a user device associated with a client device that is emulated by the client device on the system 600.

In some embodiments, the system 600 may also or alternatively include the capture device 612 and/or the encoding device 614. The capture device 612 may, for example, be utilized to capture information from a user device, a client device, and/or the emulated user device 610. In the case that the system 600 receives and/or transmits audio and/or video information and/or other videophone session information, for example, the capture device 612 may include a video capture device and/or an audio capture device. The capture device 612 may, according to some embodiments, record, store, and/or otherwise process output generated by one or more user devices. The capture device 612 may, for example, be utilized to capture audio and/or video information to provide to the emulated user device 610 (e.g., in connection with a videophone session).

According to some embodiments, audio and/or video information (e.g., captured from a user device) may be encoded and/or compressed prior to providing the output to a client device and/or to the emulated user device 610. The encoding device 614 may, for example, encode and/or compress the audio and/or video information captured by the capture device 612. The encoded and/or compressed information may then, for example, be transmitted to a client device and/or to the emulated user device 610 to facilitate, manage, and/or conduct a videophone session.

The memory device 616 may be or include, according to some embodiments, one or more magnetic storage devices, such as hard disks, one or more optical storage devices, and/or solid state storage. The memory device 616 may store, for example, the operating system 618, the device drivers 620 (e.g., to interface with the input device 608, the display device 606, and/or the emulated user device 610), and/or the switching module 622. The device drivers 620 may, according to some embodiments, include one or more Windows® Human Interface Device (HID) drivers to provide an interface between a bus driver (such as a USB driver) and an input device (e.g., the emulated user device 610). In some embodiments, the device drivers 620 may also or alternatively include one or more other drivers and/or driver types such as one or more USB drivers.

The switching module 622 may be or include any type and/or configuration of application that is configured (and/or configurable) to direct, route, and/or manage videophone session information. In some embodiments, the switching module 622 may be a software application such as a GUI. The switching module 622 may, for example, include program code that is executable by the processor 602 to perform various functions as described herein. According to some embodiments, the switching module 622 may be executed entirely within and/or on the system 600 (e.g., by the processor 602). In some embodiments, a component of the switching module 622 and/or a related application (e.g., a thin-client) may operate on a separate and/or distinct device and/or system. A client device and/or an associated user device may, for example, operate a switching client associated with the switching module 622 to facilitate videophone communication between user devices.

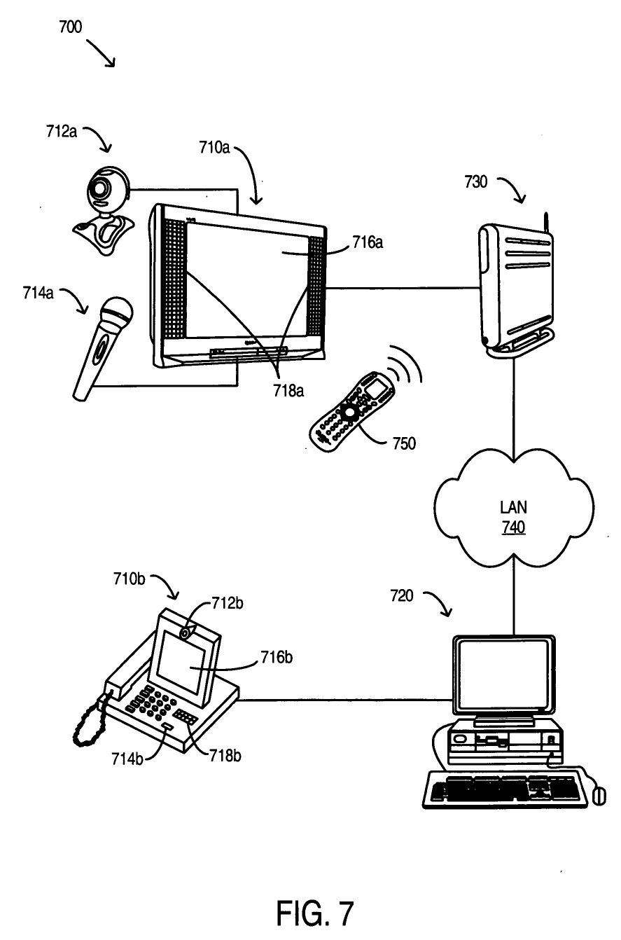

Turning now to FIG. 7, a block diagram of a system 700 according to some embodiments is shown. The system 700 may, for example, be utilized to implement and/or perform the methods 300, 500 described herein and/or may be associated with the systems 100, 200, 400, 600 described in conjunction with any of FIG. 1, FIG. 2, FIG. 4, and/or FIG. 6. In some embodiments, fewer or more components than are shown in FIG. 7 may be included in the system 700. According to some embodiments, different types, layouts, quantities, and configurations of systems may be used.

The system 700 may include, according to some embodiments, one or more user devices 710a-b. The user devices 710a-b may include, for example, a camera 712a-b, a microphone 714a-b, a display device 716a-b, and/or a speaker 718a-b. The system 700 may also or alternatively include one or more host devices 720 and/or one or more client devices 730. The client device 730 may, according to some embodiments, include a remote control interface 732. The user devices 710a-b, the host device 720, and/or the client device 730 may, according to some embodiments, be coupled, connected, and/or otherwise in communication (e.g., via a network such as the LAN 740). In some embodiments, the components 710, 712, 714, 716, 718, 720, 730, 740 of the system 700 may be similar in configuration and/or functionality to the similarly-named components described in conjunction with any of FIG. 1, FIG. 2, FIG. 4, and/or FIG. 6. In some embodiments, fewer or more components than are shown in FIG. 7 may be included in the system 700.

In some embodiments, the first user device 710a may be or include a TV and/or a combination of devices such as a TV display 716a, TV speakers 718a (and/or other speakers), a USB camera 712a, and/or a USB microphone 714a. The first user device 710a may, for example, be a home entertainment center (and/or portions of a home entertainment system) that are operated by a first user. According to some embodiments, the home entertainment system of the first user may also or alternatively include the client device 730. The client device 730 may, for example, be a wired or wireless DMA device connected to a LAN 740 such as the first user's home network.

According to some embodiments, the first user may desire to conduct a videophone session with a second user operating a second user device 710b. The second user device 710b may, for example, be a wired videophone comprising a camera 712b, a microphone 714b, a display device 716b, and/or a speaker 718b. In some embodiments, the second user device 710b may be coupled to the same LAN 740 as the first user device 710a. According to some embodiments, the second user device 710b may, such as in the case that the LAN 740 includes and/or is connected to another network (such as the Internet), be connected to a different network than the first user device 710a.

The DMA device 730 may, according to some embodiments, be coupled to and/or otherwise in communication with the host device 720 via the LAN 740. The host device 720 may, for example, be or include a PC, such as a PC connected to the first user's home network. In some embodiments, the first user may utilize a remote control 750 to send commands to the DMA device 730. The DMA device 730 may, according to some embodiments, provide a GUI to the TV display 716a (and/or otherwise cause a GUI to be displayed on the TV display 716a). The GUI may, for example, provide an interface via which the first user may utilize the remote control 750 to interact with the DMA device 730.

In some embodiments, the first user may utilize the remote control 750 to indicate that the first user desires to initiate a videophone session. The first user may, for example, push one or more pre-defined buttons on the remote control 750 (e.g., a “Videophone” button) and/or may select an option from the GUI indicative of a desire to initiate a videophone session. According to some embodiments, the GUI may include one or more icons and/or pictures, such as icons and/or pictures representing parties that the first user may contact via videophone. Pictures of various other users (e.g., users stored as contacts by the first user and/or other users connected to and/or associated with the system 700) may be provided via the TV display 716a to the first user, for example. In some embodiments, the first user may select the image of the second user to indicate that the first user desires to initiate a videophone call with the second user. According to some embodiments, the first user may otherwise select and/or identify the second user (e.g., by entering an identifier associated with the second user—such as an IP address or a phone number).

The DMA device 730 may, according to some embodiments, determine that the first user desires to contact the second user. The DMA device 730 may then, for example, send one or more messages via the LAN 740 to the host PC 720. According to some embodiments, the messages sent by the DMA device 730 may include USB packets sent via IP. In some embodiments, the messages may be converted and/or otherwise processed to emulate the first user device 710a as a USB device on the host PC 720. The host PC 720 may receive the messages, for example, as if they originated from a USB device connected directly to the host PC 720. In some embodiments, the host PC 720 may load a driver and/or execute other software to facilitate receipt, interpretation, and/or usage of the messages sent from the DMA device 730.

According to some embodiments, the host PC 720 may include switching software (and/or hardware) that allows the host PC 720 to determine the party intended as the second party to the videophone session. The host PC 720 may, for example, be in communication with a plurality of user devices that may be capable of participating in a videophone session. The information sent by the DMA device 730 may, according to some embodiments, include information indicative of the intended called party. The information may include, for example, the called party's name, an identifier associated with the called party, and/or another indication of the intended called party. In some embodiments, the selection of the second user's picture by the first user may cause the name, address, and/or identity of the second user to be indicated by the DMA device 730 to the host PC 720.

The host PC 720 may, in some embodiments, complete the initiation of the videophone session by sending information to the second user device 710b. The host PC 720 may, for example, send a signal to the second user device 710b that causes the second user device 710b to ring and/or otherwise indicate an incoming videophone call. The host PC 720 and the DMA device 730 may then, for example, route, relay, pass, and/or otherwise exchange videophone session information between the first and second user devices 710a-b. Audio from the first user may be input into the microphone 714a, for example, and then sent to the DMA device 730, relayed to the host PC 720, and then passed to the speaker 718b of the second user device 710b. Audio and/or video information input into either the first or second user device 710a-b may similarly be exchanged between the user devices 710a-b utilizing the DMA device 730 and the host PC 720, throughout the duration of the videophone session.

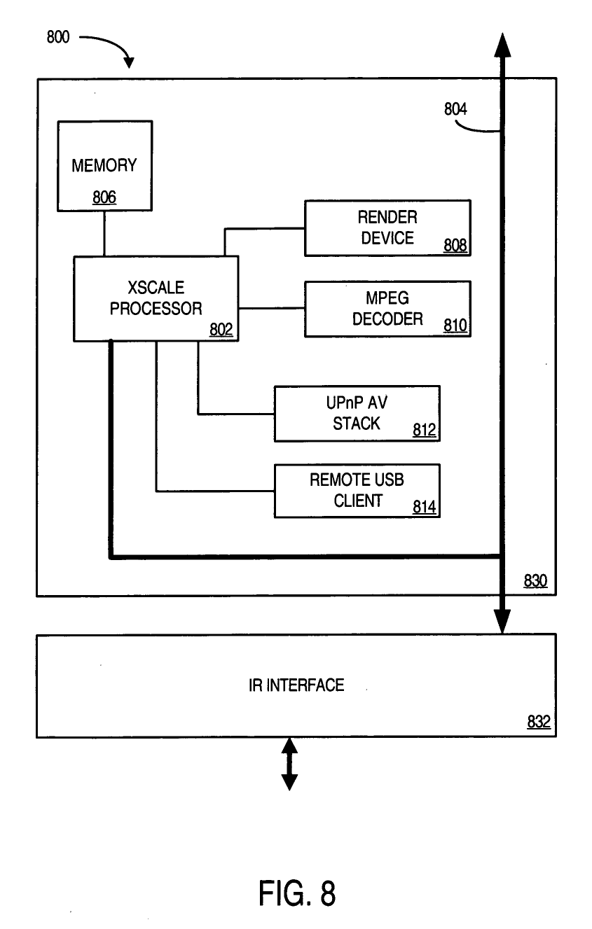

Turning now to FIG. 8, a block diagram of a system 800 according to some embodiments is shown. The system 800 may, for example, be associated with the method 300 described above and/or may be similar in configuration and/or functionality to the systems 100, 200, 400, 600 described in conjunction with any of FIG. 1, FIG. 2, FIG. 4, and/or FIG. 6. In some embodiments, the system 800 may be or include a DMA device such as the client devices 130, 230, 730 described herein. Fewer or more components that are shown in FIG. 8 may, according to some embodiments, be included in the system 800. In some embodiments, the components 802, 804, 806, 808, 810, 812, 814, 830, 832 of the system 800 may be similar in configuration and/or functionality to the similarly-named components described in conjunction with any of FIG. 1, FIG. 2, FIG. 4, FIG. 6, and/or FIG. 7 herein.

The system 800 may, according to some embodiments, include an XScale® Processor 802 (such as an Intel® PXA270 XScale® processor) and/or any other type of processor that is or becomes known, a network interface 804, a memory 806, a render device 808, an MPEG decoder 810, an UPnP Audio Visual (AV) stack 812, and/or a remote USB client 814. In some embodiments, the system 800 may also or alternatively comprise a DMA device 830 and/or an IR interface 832. The DMA device 830, as shown in FIG. 8 for example, may comprise one or more of the components 802, 804, 806, 808, 810, 812, 814 of the system 800. According to some embodiments, the IR interface 832 may be either separate from or integrated with the DMA device 830.

The network interface 804 may comprise any number, type, and/or configuration of network interface devices and/or components that are or become known. In some embodiments, the network interface 804 may include, for example, a NIC configured for communication over an IP network and/or a NIC configured for wireless 802.11a/b/g, Bluetooth®, and/or RF communications. The memory 806 may comprise, for example, any type of memory for storing data, such as Single Data Rate Random Access Memory (SDR-RAM), Double Data Rate Random Access Memory (DDR-RAM), and/or Programmable Read Only Memory (PROM).

In some embodiments, the DMA device 830 may utilize the network interface 804 to communicate with one or more host devices and/or user devices over one or more networks. The system 800 may, according to some embodiments, communicate with a host device to implement embodiments as described herein. The remote USB client 814 may, for example, emulate a user device as a USB device local to a remote USB host computer. Information from a user device may be received via the network interface 804, for example. In some embodiments, the information may comprise audio and/or video information associated with a videophone session. According to some embodiments, the DMA device 830 may covert, process, and/or otherwise utilize the information to create one or more USB packets.

In some embodiments, the USB packets may be transmitted (e.g., via the network interface 804) to a host and/or a remote host over an IP network (and/or another type of network). The host may utilize the USB packets as if they were received from a locally-connected USB device. The host may, for example, supply the information from the emulated USB device to another user device. In some embodiments, the other user device may respond by providing information to the remote USB host. The remote USB host may then, for example, forward the response information back to the system 800 (e.g., via the network interface 804). The MPEG decoder 810 may, for example, decode and/or decompress any received information and provide the information to the render device 808. According to some embodiments, the render device 808 may utilize the information received from the host device to render audio and/or video associated with the videophone session on a user device (e.g., on the user device that originated the videophone call).

According to some embodiments, the system 800 and/or the DMA device 830 may include the UPnP AV stack 812. The UPNP AV stack 812 may, for example, be or include software, hardware, and/or firmware that allows and/or facilitates device discovery. The UPNP AV stack 812 may, for example, allow the system 800 and/or the DMA device 830 to detect and/or identify any or all devices capable of communicating via the network interface 804. For example, any user devices and/or remote USB host devices that are active and/or otherwise available on a network may be identified and/or discovered by the system 800 and/or the DMA device 830 utilizing the UPNP AV stack 812. In such a manner, for example, user devices may be connected and/or disconnected from the communication interface 804 while maintaining automated configuration and/or operation of the system 800.

In some embodiments, the system 800 and/or the DMA device 830 may receive information and/or commands via the IR interface 832. A user utilizing a remote control device (e.g., the remote control 750) may, for example, interact with the DMA device 830 by sending information via the IR interface 832. The user may, according to some embodiments, select and/or define videophone options and/or configuration parameters to be utilized in establishing and/or conducting a videophone session (e.g., with a remote user device). In some embodiments, the user may utilize the remote control to define one or more user devices and/or components. In the case that the user desires to utilize a PC and/or other equipment (such as a TV) as a videophone, for example, the user may interact with the system 800 to define and/or select components and/or devices that are desired for use in conducting a videophone session. As an example, the user may select a TV to utilize to view a called party, a speaker and/or headset to utilize to hear the called party, a microphone to utilize to speak to the called party, and/or a camera to utilize to allow the called party to see images of the user. In such a manner, for example, the user may utilize the system 800 to conduct a videophone session utilizing one or more devices or components to define and/or create a videophone (e.g., a virtual videophone).

The several embodiments described herein are solely for the purpose of illustration. Those skilled in the art will note that various substitutions may be made to those embodiments described herein without departing from the spirit and scope of the present invention. Those skilled in the art will also recognize from this description that other embodiments may be practiced with modifications and alterations limited only by the claims.

What is claimed is:

1. A method, comprising:
receiving first audio and video information from a first user device;
emulating the first user device as a universal serial bus device directly connected to a universal serial bus host;
receiving, from the universal serial bus host, second audio and video information associated with a second user device; and
sending the second audio and video information to the first user device.

2. The method of claim 1, further comprising:
identifying the universal serial bus host.

3. The method of claim 1, further comprising:
identifying the first user device.

4. The method of claim 1, further comprising:
decoding the second audio and video information.

5. The method of claim 1, wherein the first audio and video information is received from a microphone and a camera.

6. The method of claim 1, wherein the sending of the second audio and video information to the first user device comprises:
sending an audio portion of the second audio and video information to a speaker; and
sending a video portion of the second audio and video information to a display device.

7. The method of claim 1, wherein the first audio and video information is received as one or more universal serial bus packets.

8. The method of claim 1, wherein the emulating comprises:
sending the first audio and video information to the universal serial bus host as one or more universal serial bus packets over an internet protocol network.

9. The method of claim 1, wherein the second audio and video information is received as one or more universal serial bus packets over an internet protocol network.

10. A method, comprising:
receiving, from a client device, first audio and video information associated with a first user device;
sending the first audio and video information to a second user device;
receiving second audio and video information from the second user device; and
sending the second audio and video information to the client device.

11. The method of claim 10, further comprising:
loading a driver associated with the first user device.

12. The method of claim 10, wherein the receiving of the second audio and video information comprises:
capturing the second audio and video information from the second user device.

13. The method of claim 10, further comprising:
encoding the second audio and video information.

14. The method of claim 10, further comprising:
identifying the client device.

15. The method of claim 10, further comprising:
identifying the second user device.

16. The method of claim 10, wherein the second user device comprises a microphone, a camera, a speaker, and a display device.

17. The method of claim 10, wherein the first and second audio and video information are transmitted as one or more universal serial bus packets over an internet protocol network.

18. A system, comprising:
a remote user device;
a first network device to receive first audio and video information from the remote user device and to send second audio and video information to the remote user device;
a second network device to send the first audio and video information to a local user device and to receive the second audio and video information from the local user device; and
an encoding device to encode the second audio and video information.

19. The system of claim 18, wherein the electronic device further includes:
a capture device to capture the second audio and video information from the user device.

20. The system of claim 18, wherein the first network device is an internet protocol communication device and the second network device is a universal serial bus communication device.

21. A system, comprising:
a network device to receive first audio and video information from a first user device;
an emulation device to emulate the first user device as a universal serial bus user device on a remote universal serial bus host device;
a decoding device to decode second audio and video information received from the remote universal serial bus host device; and
a wireless interface to receive information from an wireless input device.

22. The system of claim 21, further comprising:
a rendering device to render the second audio and video information on the first user device.

23. The system of claim 21, wherein the second audio and video information is associated with a second user device.
